(19) United States
(12) Patent Application Publication
(10) Pub. No.: US 2018/0278741 A1
(43) Pub. Date: Sep. 27, 2018

(54) DEVICE AND METHOD FOR CONTROLLING MOBILE TERMINAL

(71) Applicant: Heon Young JANG, Yongin-si (KR)

(72) Inventor: Heon Young JANG, Yongin-si (KR)

(21) Appl. No.: 15/764,183

(22) PCT Filed: Sep. 30, 2016
(86) PCT No.: PCT/KR2016/011003

§ 371 Date: Mar. 28, 2018

(30) Foreign Application Priority Data
Oct. 1, 2015 (KR) 10-2015-0138732

(51) Int. Cl. H04M 1/725; G06K 9/00; G06T 7/60

(52) U.S. Cl. CPC H04M 1/72577; G06T 7/60; G06K 9/00369

(57) ABSTRACT

A device and a method for controlling a mobile terminal are disclosed. The present invention provides a device and a method for controlling a mobile terminal, the device and the method turning off a display unit when the mobile terminal becomes closer than a reference length, which is a standard distance, and turning off the display unit when a user does not view the display unit with correct posture or a view time of a display exceeds a preset time limit range, thereby preventing the user from using the mobile terminal at a short distance and with incorrect posture for a long time.

### CROSS-REFERENCE TO RELATED APPLICATIONS

This patent application is a national-stage application of International Patent Application No. PCT/KR2016/011003, filed on Sep. 30, 2016, which claims priority under 35 U.S.C. § 119 to Korean Patent Application No. 10-2015-0138732, filed on Oct. 1, 2015, in the Korean Intellectual Property Office, the disclosure of which is incorporated by reference herein in its entirety.

### TECHNICAL FIELD

The present invention relates to devices and methods for controlling mobile terminals.

### DISCUSSION OF RELATED ART

Generally, mobile terminals are portable devices featuring one or more of voice and video calling, inputting/outputting information, and storing data.

The recent spread of smartphones or other smart devices leads to mobile terminals evolving multimedia devices that come with more diversified features, e.g., photographing or video recording, playing music or video files, receiving broadcast, or other sophisticated features.

Mobile terminals have a limited-size display. Thus, the user of a mobile terminal tends to bring it closer to his eyes to view, thus suffering from eye fatigue and damage to his vision.

Meanwhile, infants or kids spend more time using mobile terminals, and negative influences that mobile terminals are becoming a social issue.

### SUMMARY

The present invention aims to a device and method for controlling a mobile terminal which, where the mobile terminal comes closer than a reference distance, i.e., a reference length, switches off the display unit, and where the user is watching in a bad posture or the watching time exceeds a limited time range, switches off the display unit, preventing the user from using the mobile terminal in a bad posture, too close to the mobile terminal, and for a long time.

To achieve the foregoing objective, according to an embodiment of the present invention, a method for controlling a mobile terminal may comprise the steps of (a) recognizing feature points from a facial image captured in a distance preset by a user and setting a distance between the recognized feature points as a reference length, (b) when an application is driven, capturing the user's face to generate a facial image and obtaining a measuring length that is a distance between feature points from the user's facial image, and (c) comparing the obtained measuring length with the set reference length, and when the obtained measuring length is longer than the set reference length, switching off a display unit.

According to an embodiment of the present invention, step (a) may include the step of receiving, from the user, and setting a limited angle range of the mobile terminal for a viewing posture, and the method may further comprise the steps of obtaining a measuring angle obtained by measuring an angle of the mobile terminal through a slope sensor, and when the obtained measuring angle is the set limited angle range, switching off the display unit.

According to an embodiment of the present invention, step (a) may include the step of receiving, from the user, and setting a limited angle range of the mobile terminal for a viewing posture, and the method may further comprise the steps of obtaining a measuring angle obtained by measuring an angle of the mobile terminal through a slope sensor, and when the obtained measuring angle is the set limited angle range, switching off the display unit.

According to an embodiment of the present invention, instead of switching off the displaying unit, the displaying unit may be darkened into a peripheral device brightness or less.

According to an embodiment of the present invention, instead of switching off the displaying unit, a predetermined message may be output on the displaying unit, a predetermined sound may be output, or an actuator of the mobile terminal may be driven.

According to an embodiment of the present invention, step (a) may include the steps of receiving the user's facial image captured in the distance preset by the user, recognizing the facial feature points from the user's facial image, setting the distance between the recognized feature points as the reference length, receiving user information corresponding to the reference length, and storing the reference length corresponding to the user information.

According to an embodiment of the present invention, the distance between the feature points may be any one of the inter-pupil distance or inter-eyebrow distance.

To achieve the above objective, according to an embodiment of the present invention, a device for controlling a mobile terminal may comprise a camera unit disposed on a front surface of the mobile terminal to capture a user's facial image, a display unit, a slope sensor measuring an angle between the display unit and a ground to obtain a measuring angle, and a controller switching off the display unit when the measuring angle of the mobile terminal is within a limited angle range, and a measuring length extracted from the user's facial image is within a reference length.

According to an embodiment of the present invention, the controller may switch off the display unit when the user's watching time exceeds a preset limited time range.

As set forth above, the present invention allows the user to view the mobile terminal in a proper posture and distance and within a preset time range, thereby protecting the user's vision.

### BRIEF DESCRIPTION OF THE DRAWINGS

FIG. 1 is a view illustrating a configuration of a mobile terminal according to an embodiment of the present invention;

FIG. 2 is a flowchart illustrating a method for setting a reference length and user information to control a mobile terminal according to an embodiment of the present invention;

FIG. 3 is a view illustrating an example of applying the method of FIG. 2 to a mobile terminal; and

FIG. 4 is a flowchart illustrating a method for controlling a mobile terminal according to an embodiment of the present invention.

### DETAILED DESCRIPTION OF EXEMPLARY EMBODIMENTS

Various changes may be made to the present invention, and the present invention may come with a diversity of embodiments. Some embodiments of the present invention are shown and described in connection with the drawings. However, it should be appreciated that the present disclosure is not limited to the embodiments, and all changes and/or equivalents or replacements thereto also belong to the scope of the present disclosure.

As set forth herein, mobile terminals may include various devices equipped with a front camera to capture the user's images, such as mobile phones, smartphones, or pad-type computers.

However, it will readily be appreciated by one of ordinary skill in the art that the configurations set forth herein according to various embodiments of the present invention may also be applicable to digital TVs, desktop computers, or other stationary terminals. In other words, digital TVs with a front camera are able to capture users' images, and thus, the present invention may be applicable to such digital TVs as well.

Hereinafter, preferred embodiments of the present invention are described in detail with reference to the accompanying drawings.

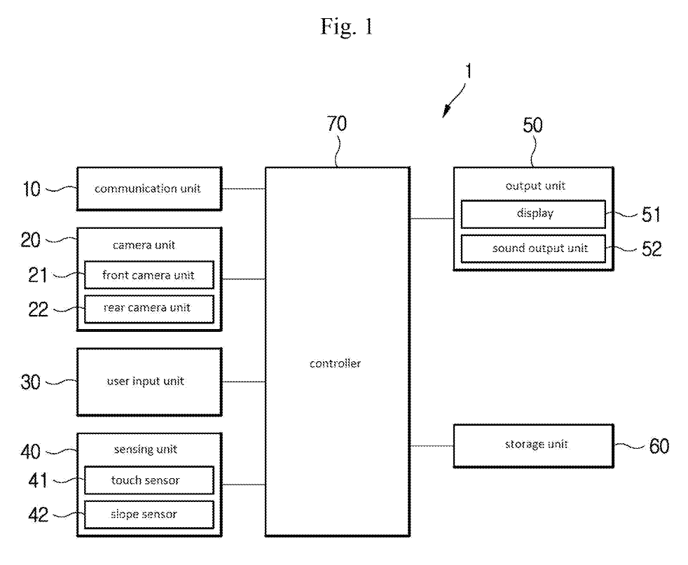

FIG. 1 is a view illustrating a configuration of a mobile terminal according to an embodiment of the present invention.

Referring to FIG. 1, according to the present invention, a mobile terminal 1 may include a communication unit 10, a camera unit 20, a user input unit 30, a sensing unit 40, an output unit 50, a storage unit 60, and a controller 70. The components of the mobile terminal 1 shown in FIG. 1 are not necessary ones, and the mobile terminal 1 may include more or less components according to implementations.

The components are described below one by one.

The communication unit 10 may include one or more modules that enable wireless communication between the mobile terminal 1 and a wireless communication system or between the mobile terminal 1 and a network where the mobile terminal 1 is positioned. For example, the communication unit 10 may include, e.g., a mobile communication module, a wireless Internet module, a short-range communication module, or a location information module.

The mobile communication module may transmit and receive wireless signals with at least one of a base station, an external terminal, or a server over a mobile communication network. In this case, the wireless signals may contain various types of data according to the transmission or reception of text/multimedia messages, video call signals, or voice call signals.

The wireless Internet module may indicate a module for accessing the wireless Internet and may be embedded in or positioned outside the mobile terminal 1. Available are wireless Internet technologies, such as WLAN (Wireless LAN) (Wi-Fi), Wibro (Wireless broadband), Wimax (World Interoperability for Microwave Access), or HSDPA (High Speed Downlink Packet Access).

The short-range communication module may be intended for short-range communication and may adopt short-range communication technologies, such as Bluetooth, RFID (Radio Frequency Identification), IrDA (infrared Data Association), UWB (Ultra Wideband), or ZigBee.

The location information module may be intended for obtaining the location of the mobile terminal 1 and may include a GPS (Global Position System) module.

The camera unit 20 may include a front camera unit 21 in the front surface of the mobile terminal 1, where a display unit 51 is positioned, and a rear camera unit 22 in the rear surface of the mobile terminal 1. The front and rear camera units 21 and 22 may be intended to process image frames, such as still images or videos, obtained by an image sensor (not shown), and the image frames processed by the front or rear camera unit 21 or 22 may be displayed on the display unit 51.

The user input unit 30 may be intended to generate input data for allowing the user to control the operation of the mobile terminal 1 and may include, e.g., a keypad, a dome switch, a touchpad (capacitive or resistive), a jog wheel, or a jog switch.

The user may enter, through the user input unit 30, various pieces of configuration information and setting information about applications that implement methods for controlling the mobile terminal 1 according to the present invention. The user may also enter, through the user input unit 30, user information to distinguish each user from another. According to the present invention, the mobile terminal control device may be shared by a number of users, and the mobile terminal control device may receive user input to distinguish each user from another. The user information may include at least one of the name, gender, age, address, or birth date of each user.

The sensing unit 40 may detect the current state of the mobile terminal 1, such as whether the mobile terminal 1 is opened or closed, the location of the mobile terminal 1, whether contacted by the user or not, the direction of the mobile terminal 1, or the acceleration/deceleration of the mobile terminal 1 and generate sensing signals to control the operation of the mobile terminal 1. In this case, the sensing unit 40 may include a touch sensor 41 and a slope sensor 42. However, this is merely an example for illustration purposes, and it is apparent that the sensing unit 40 may include other sensors as well.

The output unit 50 may be intended to generate visual or audible outputs and may include the display unit 51 and a sound output unit 52.

The display unit 51 may display information processed on the mobile terminal 1. For example, where the mobile terminal 1 is in a call mode, the display unit 51 may display a call-related user interface (UI) or graphic user interface (GUI), and where the mobile terminal 1 is in a capture mode, the display unit 51 may display still images or videos captured.

The display unit 51 may include at least one of a liquid crystal display (LCD), a thin film transistor-liquid crystal display (TFT-LCD), an organic light-emitting diode (OLED), a flexible display, or a three-dimensional (3D) display).

There may be two or more display units 51 according to the implementation of the mobile terminal 1. For example, a plurality of display units may be arranged integrally or spaced apart from each other on one surface of the mobile terminal 1 or may be arranged on their respective corresponding surfaces of the mobile terminal 1.

Where the display unit 51 and a sensor (e.g., the touch sensor 41) for detecting touches are mutually layered in structure (hereinafter, referred to as a “touchscreen”), the display unit 51 may be used as an input device, like the user input unit 30, as well as an output device. The touch sensor 41 may be implemented in the form of, e.g., a touch film, a touch sheet, or a touch pad.

The touch sensor 41 may be configured to convert a pressure applied to a particular portion of the display unit 51 or a variation in capacitance that arises in a particular portion of the display unit 51 into an electrical input signal. The touch sensor 41 may be configured to be able to detect the pressure upon touching, as well as the position and area of the touch.

Where a touch input is made on the touch sensor 41, its corresponding signal is transmitted to a touch controller (not shown). The touch controller may process the signal and transmit its corresponding data to the controller 70. Thus, the controller 70 may be aware what area has been touched in the display unit 51. The relevant operations are apparent to one of ordinary skill in the art to which the present invention pertains, and no detailed description thereof is given herein.

The sound output unit 52 may output audio data stored in the storage unit 60 or received from the communication unit 10 in, e.g., a call reception, call or recording mode, voice recognition mode, or broadcast reception mode. The sound output unit 52 may also output sound signals related to functions (e.g., call ring tones or message ring tones) performed on the mobile terminal 1. The sound output unit 52 may include, e.g., a receiver, a speaker, and a buzzer.

The storage unit 60 may store a program for the operation of the controller 70 and temporarily store data input or output. According to an embodiment of the present invention, the storage unit 60 may also store an application for controlling the mobile terminal 1 according to the present invention.

The storage unit 60 may store not only various pieces of configuration information and setting information for the application to control the mobile terminal 1 but also user input to distinguish between users. The storage unit 60 may store each user's facial image, feature points recognized as per each user's facial image, and a reference length corresponding to each user's user information.

The storage unit 60 may include at least one type of storage medium of flash memory types, hard disk types, multimedia card micro types, card types of memories (e.g., SD or XD memory cards), RAMs (Random Access Memories), SRAMs (Static Random Access Memories), ROMs (Read-Only Memories), EEPROMs (Electrically Erasable Programmable Read-Only Memories), PROMs (Programmable Read-Only Memories), magnetic memories, magnetic disks, or optical discs. The mobile terminal 1 may be operated in association with web storage that performs the storage function of the storage unit 60 over the network.

The controller 70 may typically perform the overall operation of the mobile terminal 1. For example, the controller 70 performs control and processing related to, e.g., voice calls, data communication, and video calls.

Further, the controller 70 may analyze a facial image captured through the camera to recognize features, obtain a measuring length for comparison from the facial image, and compare the obtained measuring length with a preset reference length and make a determination thereon.

Operations of the controller 70 are described below in detail with reference to the drawings.

Various embodiments described herein may be implemented in a computer (or its similar device)-readable recording medium using software, hardware, or a combination thereof.

When implemented in hardware, the embodiments described herein may be implemented using at least one of ASICs (application specific integrated circuits), DSPs (digital signal processors), DSPDs (digital signal processing devices), PLDs (programmable logic devices), FPGAs (field programmable gate arrays), processors, controllers, micro-controllers, microprocessors, or electrical units for performing other functions. In some cases, the embodiments set forth herein may be implemented in the controller 70 itself.

When implemented in software, embodiments, e.g., procedures and functions, of the present invention may be implemented in separate software modules. Each of the software modules may perform one or more functions and operations described herein. Software code may be implemented into a software application written in a proper programming language. The software code may be stored in the storage unit 60 and executed by the controller 70.

Now described in detail is a method for controlling a mobile terminal according to an embodiment of the present invention.

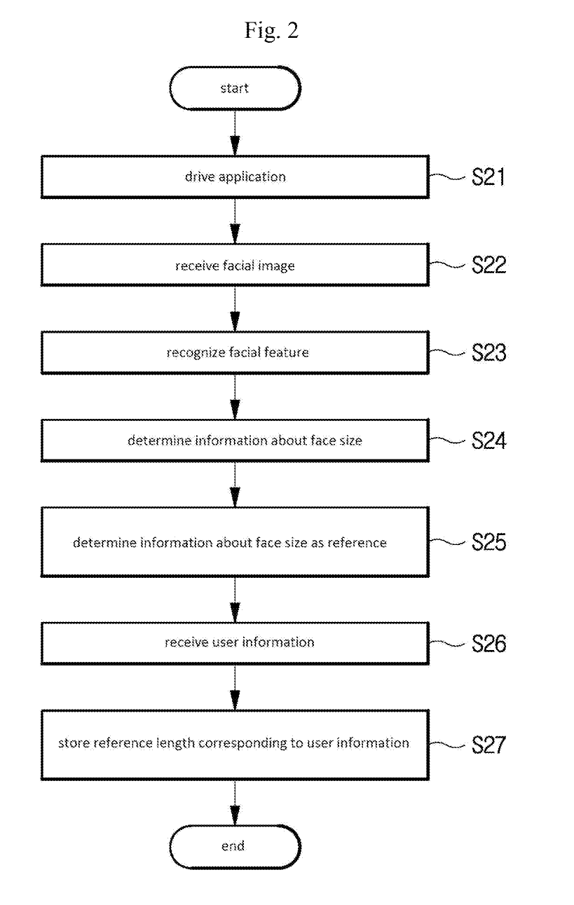

FIG. 2 is a flowchart illustrating a method for setting user information and a reference length to control a mobile terminal according to an embodiment of the present invention.

As shown in FIG. 2, if the user drives an application for the present invention (S21) and the controller 70 determines that a setting is needed, then the controller 70 may drive the front or rear camera unit 21 or 22 to receive a facial image in a distance set by the user (S22).

Here, the distance set by the user is the distance between the user's eyes and the display unit 51 of the mobile terminal. The user-set distance may be measured using, e.g., a measuring tape, and the camera may be positioned in the distance. Or, a child's parent may put the mobile terminal in the child's hand, with the child's arm stretched out, and in this position, the facial image may be captured.

The controller 70 may recognize the features and feature points, such as the contour, eyes, and eyebrows of the face, from the facial image received from the front or rear camera unit 21 or 22 of the mobile terminal which is positioned the user-set distance away (S23) and determine information about the face size from the recognized features (S24). The information about the face size may be the distance between the pupils or the distance between the eyebrows. However, this is merely an example, and various types of information about the face size may be determined according to an embodiment of the present invention.

The controller 70 may determine, as a reference length, the information about the face size obtained from the facial image captured by the mobile terminal the user-set distance away (S25) and send a request for information about the user and receive the information (S26). Thereafter, the controller 70 may store the reference length corresponding to the user information in the storage unit 60.

As such, the controller 70 may receive the information about the user's face size in the distance set by the user, set the information as the reference length, and use the reference length to control the mobile terminal later.

Meanwhile, although not shown in FIG. 2, the user may set not only the reference length but also a limited angular range of the mobile terminal for the user's viewing posture, and a limited time range to limit the user's total watching time.

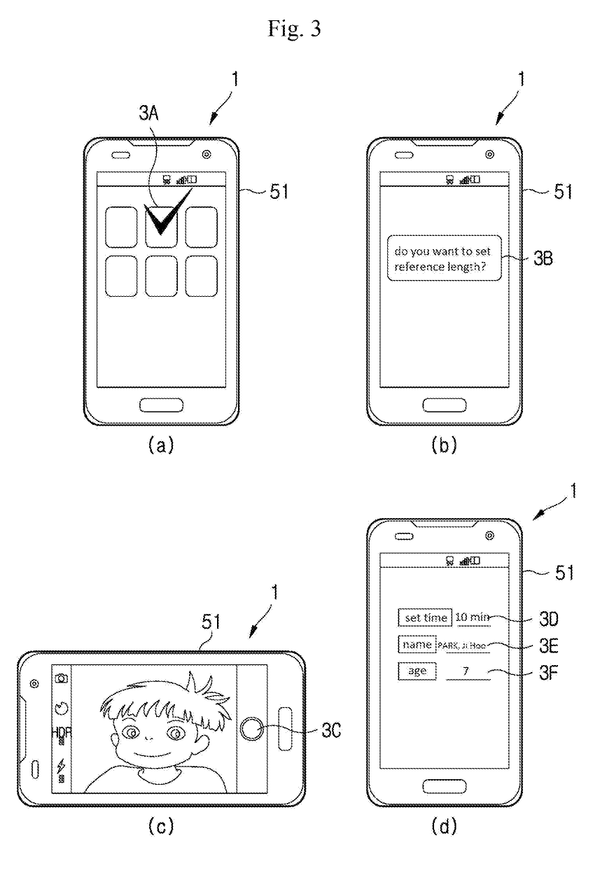

FIG. 3 is a view illustrating an example of applying the method of FIG. 2 to a mobile terminal. For illustration purposes, the owner of the mobile terminal 1 is referred to as user 1, and a user permitted by user 1 to use the mobile terminal 1 is referred to as user 2. For example, user 1 is a mom, and user 2 is her child. For ease of description, users 1 and 2 only are described, but more users may be added.

As shown in FIG. 3(a), user 1 may select an icon 3A corresponding to an application for a method, according to an embodiment of the present invention, among icons corresponding to a plurality of applications, on the display unit 51 of the mobile terminal 1 (the symbol ‘√’ indicates that the icon has been selected). At this time, where there is no setting made for user 2, the controller 70 may display a message 3B to request that a setting be made as shown in FIG. 3(b). However, this is merely an example. For example, user 1, after entry into the application, may select the settings ion to enter the settings.

Thereafter, the controller 70 may drive the rear camera unit 22 and display a preview image as shown in FIG. 3(c). This example is about the case where the mom, i.e., user 1, captures her kid, i.e., user 2. In this example shown, user 1 determines how away she wants user 2 to be positioned to view the screen of the display unit 51 of the mobile terminal 1 and captures user 2's image in the position. However, this is a mere example. The controller 70 may drive the front camera unit 21 to directly capture user 1's own facial image. To obtain a still image from the preview image, the capture icon 3C displayed on the display unit 51 may be touched.

Thereafter, the controller 70 may receive the still facial image, recognize facial features from the facial image, determine information bout the face size, and set the information as the reference length. According to an embodiment of the present invention, although an example is described in which the inter-pupil distance is determined as the information about the face size, the present invention is not limited thereto.

Thereafter, the controller 70 may send a request for information about user 2 to which the present invention is to be applied and receive the information. The information about user 2 may include a set time corresponding to a limited time range, name, and age, as set forth above.

The controller 70 may store, in the storage unit 60, the reference length corresponding to the information about user 2.

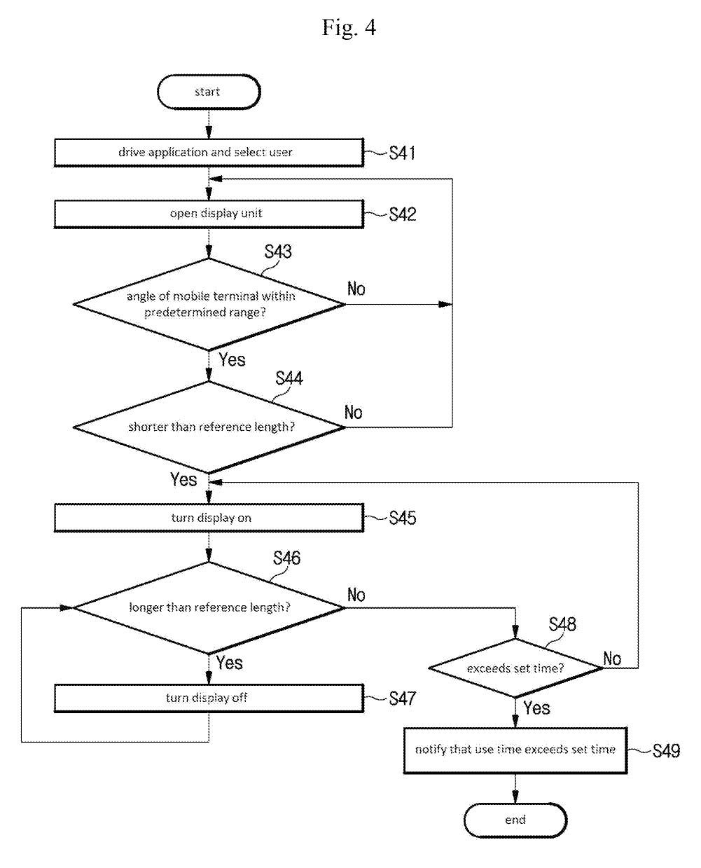

FIG. 4 is a flowchart illustrating a method for controlling a mobile terminal according to an embodiment of the present invention.

As shown in FIG. 4, according to an embodiment of the present invention, if user 1 selects an icon corresponding to an application according to an embodiment of the present invention, the controller 70 executes the application according to an embodiment of the present invention and determines a user to use the application (S41).

The controller 70 may allow it to be selected which user the application is applied to, and the controller 70 may receive a selection indicating that user 2 is to use, from user 1.

Meanwhile, immediately when the application is executed, the controller 70 may drive the camera to capture the facial image of the user to use the application and compare, and search for, the captured facial image with facial images stored in the storage unit 60, thereby identifying and determining the captured user. Meanwhile, the controller 70 may gather the facial images of user 1 and user 2 to identify and determine user 1 and user 2, or the controller 70 may gather the facial image of user 2 alone and determine user 2 who views the image output from the display unit 51.

Thereafter, if user 2 views the mobile terminal 1 in his hand, the controller 70 may obtain a measuring angle, which is an angle between the display unit 51 of the mobile terminal 1 and the ground, from the slope sensor 42 of the mobile terminal 1 and identify whether the obtained measuring angle of the mobile terminal 1 is within a preset limited angle range (S42). Here, the measuring angle means the angle between the ground and a straight line that is perpendicular to the display 51 and passes through the center of the display unit 51. Where the user is viewing the display unit 51 in a proper fixed position, the measuring angle is within a particular limited angle range.

To that end, the controller 70 may previously set and store the limited angle range which is a range for determining at what angle the mobile terminal 1 is in the proper position. However, this is merely an example, and user 1 may previously set the same in the settings of FIG. 2.

Where the measuring angle of the mobile terminal 1 escapes off the predetermined limited angle range, the controller 70 switches off the display unit 51 (S46).

Further, where the measuring angle of the mobile terminal 1 is within the determined limited angle range, the controller 70 may receive user 2's facial image from the front camera unit 21, extract and obtain the measuring length which is the distance between featuring points from the received facial image, and compare the obtained measuring length with the reference length, thereby identifying whether the measuring length is equal or shorter than the reference length (S43).

Here, the measuring length means the distance between featuring points in the image, and the measuring length is not the actual length of the object but the length measured through the image. Accordingly, if the face of the same person is captured with the distance from the mobile terminal varied, then the measuring length reduces as the distance increases.

For example, where the measuring length is determined as the inter-pupil distance, the inter-pupil distance may be measured from the facial image of user 2 received from the front camera unit 21, and where the measuring length, which is the inter-pupil distance measured, is longer than the reference length, it can be shown that the mobile terminal 1 is located in a distance shorter than the distance set by user 1.

Accordingly, where the measuring distance obtained from the facial image of user 2 received from the front camera unit 21 is equal or shorter than the reference length, the controller 70 may keep the display unit 51 on, and where the measuring distance obtained from the facial image of user 2 is longer than the reference length, the controller 70 may switch off the display unit 51 (S46).

Thereafter, the controller 70 may determine whether the time during which user 2 has watched the mobile terminal 1 is within a limited time range (S43). In other words, the controller 70 may identify the time when user 1 selected the icon corresponding to the application or the time when the display unit 51 switched on in S45 and identify whether the time duration during which the display unit 51 has been viewed since the identified time exceeds the limited time range.

Whether the watching time duration exceeds the limited time range, the controller 70 switches off the display unit 51 (S46).

Meanwhile, where the watching time duration is within the limited time range, the controller 70 keeps the display unit 51 on and returns to step S42. Of course, where, after the display unit 51 switches off in step S46, the measuring angle of the mobile terminal is within the determined limited angle range and the measuring length obtained from the facial image is equal or shorter than the reference length as per steps S42 to S44, and the watching time duration is within the limited time range, then the controller 70 may switch the display unit 51 from off to on.

As such, where the measuring angle of the mobile terminal 1 is within the determined limited angle range, the distance between the mobile terminal 1 and user 2 is equal or larger than the preset distance (the measuring length obtained from the facial image is shorter than the reference length), and the watching time duration of the mobile terminal 1 is within the set limited time range, the controller 70 may keep the display unit 51 on, so that user 2 is allowed to view the display unit 51 of the mobile terminal 1 only when user 2 views within the limited time range while leaving the mobile terminal 1 a proper distance or more away in a proper posture, thus protecting user's 2 vision.

Meanwhile, although FIG. 4 illustrates an example in which the display unit 51 is kept on only when the measuring angle related to the viewing position, the measuring length related to the viewing distance, and the viewing time duration are within their respective preset ranges, whether to keep the display unit on may also be determined by combinations of the measuring angle, measuring length, and viewing time duration. For example, such settings may also be made as to keep the display unit 51 on once the measuring length is equal or shorter than the reference length or once the viewing position is proper, or the condition for leaving the display unit 51 on may be determined in combinations of various schemes.

Meanwhile, although not shown in the drawings, the controller 70 may, instead of switching off the display unit in step S46, alert the user of the corresponding event (S47). In other words, if the distance between the mobile terminal 1 and user 2 decreases, user 2 is not in the proper position, or user 2's watching time duration exceeds the preset time, the controller 70 may switch off the display unit 51 or alert the user to the corresponding event to bring user 1 or user 2 to the attention.

By so doing, the controller 70 leaves the mobile terminal 1 and user 2 to remaining at a peripheral device distance or more and allows user 2 to watch in a proper position, preventing user 2 from watching in excess of the limited time range.

However, this is merely an example. The controller 70 may alert user 1 or user 2 to a violation on the viewing distance, viewing posture, and viewing time duration by various schemes, such as fading out the display unit 51 rather than immediately switching off or changing the darkness depending on the viewing distance, posture, or time duration.

Or, the controller 70 may also be configured to output alert text on the display unit 51 simultaneously or separately from switching off or darkening the display unit 51, enabling the sound output unit 52 to output a predetermined audible alarm, or driving an actuator (not shown) in the mobile terminal 1 to allow user 2 to feel in a visible, audible, or tactile manner.

Thus, the present invention allows user 2 to view the mobile terminal in a proper posture, an adequate distance away, during a preset time, protecting user 2's vision.

Although in the examples of the present invention user 1 and user 2 are separate ones, the present invention may likewise apply even where they are the same user.

The above-described methods of the present invention may be implemented as computer-readable code in a recording medium. The computer-readable recording medium includes all types of recording devices storing data readable by a computer system. Examples of the computer-readable recording medium include ROMs, RAMs, CD-ROMs, magnetic tapes, floppy disks, or optical data storage devices, or carrier wave-type implementations (e.g., transmissions through the Internet). Further, the computer-readable recording medium may be distributed to computer systems connected via a network, and computer-readable codes may be stored and executed in a distributed manner.

The embodiments set forth herein are merely examples, and it will be apparent to one of ordinary skill in the art that various changes may be made thereto without departing from the scope of the present disclosure. The scope of the present disclosure should be defined by the following claims.

1. A method for controlling a mobile terminal, the method comprising the steps of:
(a) recognizing feature points from a facial image captured in a distance preset by a user and setting a distance between the recognized feature points as a reference length;
(b) when an application is driven, capturing the user's face to generate a facial image and obtaining a measuring length that is a distance between feature points from the user's facial image; and
(c) comparing the obtained measuring length with the set reference length, and when the obtained measuring length is longer than the set reference length, switching off a display unit.

2. The method of claim 1, wherein step (a) includes the step of receiving, from the user, and setting a limited angle range of the mobile terminal for a viewing posture, and wherein the method further comprises the steps of obtaining a measuring angle obtained by measuring an angle of the mobile terminal through a slope sensor, and when the obtained measuring angle is the set limited angle range, switching off the display unit.

3. The method of claim 1, wherein step (a) includes the step of receiving, from the user, and setting a limited time range, and wherein the method further comprises the steps of obtaining a watching time, which is time duration during which the user views since the display unit switches on, and when the obtained watching time is the set limited time range, switching off the display unit.

4. The method of claim 1, wherein the display unit is darkened to a predetermined brightness or less instead of switching off the display unit.

5. The method of claim 1, wherein a predetermined message is output on the display unit, a predetermined sound is output, or an actuator of the mobile terminal is driven instead of switching off the display unit.

6. The method of claim 1, wherein step (a) includes the steps of receiving the user's facial image captured in the distance preset by the user, recognizing the facial feature points from the user's facial image, setting the distance between the recognized feature points as the reference length, receiving user information corresponding to the reference length, and storing the reference length corresponding to the user information.

7. The method of claim 1, wherein the distance between the feature points is any one of a distance between the pupils of the user or a distance between the eyebrows of the user.

8. A device for controlling a mobile terminal, comprising a camera unit disposed on a front surface of the mobile terminal to capture a user's facial image, a display unit, a slope sensor measuring an angle between the display unit and a ground to obtain a measuring angle, and a controller switching off the display unit when the measuring angle of the mobile terminal is within a limited angle range, and a measuring length obtained from the user's facial image is within a reference length.

9. The device of claim 8, wherein the controller switches off the display unit when the user's watching time exceeds a preset limited time range.
